(19) United States
(12) Patent Application Publication
(10) Pub. No.: US 2024/0040979 A1
(43) Pub. Date: Feb. 8, 2024

(54) ACTIVE POSITION NOZZLE IDENTIFICATION SYSTEM AND METHOD

(71) Applicant: DEERE & COMPANY, MOLINE, IL (US)

(72) Inventor: PETER HLOBEN, HEIDELBERG (DE)

(21) Appl. No.: 18/357,270

(22) Filed: Jul. 24, 2023

(30) Foreign Application Priority Data
Aug. 3, 2022 (EP) 22188466.1

(51) Int. Cl. A01G 25/16; G06K 19/077; G06K 7/10

(52) U.S. Cl. CPC A01G 25/16; G06K 19/07758; G06K 7/10316

(57) ABSTRACT

An agricultural machine includes a chassis, a liquid tank, a spray boom assembly, and a conduit. A nozzle body including a plurality of nozzles is located on a bottom side of the boom. A transponder tag is placed on each nozzle of the nozzle body and includes specific information regarding characteristics of the respective nozzle. A reader assembly emits electromagnetic waves through an antenna to receive information from a particular transponder tag. The transponder tag receives the electromagnetic waves and generates a signal that includes the specific information. Each nozzle is movable into an active position by rotation of a nozzle turret. The reader assembly is located such that a transponder tag of a nozzle enters communication range when the nozzle is placed in the active position. A controller receives the specific information and identifies characteristics of the nozzle in the active position.

### CROSS-REFERENCE TO RELATED APPLICATIONS

This application claims the benefit of European Patent Application 22188466.1, filed Aug. 3, 2022. The entire disclosure of the application referenced above is incorporated by reference.

### FIELD

The present disclosure relates to agricultural machines, particularly to agricultural sprayers and more particularly to a system and a method of identifying a nozzle, mounted on a spray boom assembly of the agricultural sprayer, in active position and its characteristics.

### BACKGROUND

To increase agricultural yield, chemical substances such as fertilizers, pesticides, insecticides, herbicides, fungicides etc. are periodically and/or selectively sprayed on targets in a field. Although, use of chemical substances is viewed as beneficial, it can also responsible for many undesirable effects, including crop damage due to toxins, environmental pollution and human illnesses. Environmental pollution includes contamination of soil, water and air.

The chemical substances sprayed over a field can stay in the soil for years or decades and continue to harm soil health due to overuse. Also, the chemical substances used for treating plants and soil can reach surface water or nearby waterbodies through runoff. In many areas, contamination of water by pesticides is widespread. Air pollution comes mainly in the form of ammonia (NH3), which enters the air as a gas from heavily fertilized fields and livestock waste. In general, during spraying operations in the field, the presence of wind causes uncontrolled drifting of the chemical substances over the entire field which can cause pollution. Even the use of an approved amount of chemical substances can have undesirable side effects.

In order to minimize the pollution, governments have set up regulations for use of spraying material and respective documentation of the same with respect to type and/or quantity of the chemicals and the type of nozzle and/or pattern. Thus, it is important to calculate the amount of spraying material spread over the field during spraying operations and to have the correct nozzle in an active position. Therefore, one object of the present disclosure is to facilitate spraying operation in compliance with said government regulations.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An agricultural machine with a system for or implementing a method of identifying which nozzle mounted on a spray boom assembly of the agricultural machine, is in an active position and its characteristics, is disclosed. The mentioned agricultural machine may be a self-propelled, trailed or mounted agricultural sprayer.

Further, the agricultural machine includes a chassis, a liquid tank, a spray boom assembly with a center frame, laterally extendable right and left booms and a conduit defining a liquid flow path associated with the spray boom assembly.

Furthermore, at least one nozzle body is placed at a bottom side of the boom. The nozzle body may include stationary and/or respectively non-rotating portions and a rotatable nozzle turret on which a plurality of nozzles are mounted. The plurality of nozzles mounted to the nozzle turret may include two or more nozzles. Further, the plurality of nozzles may include flat tapered fan, flat even fan, deflect, anvil/flood, full cone or hollow cone, twin spray, single or multiple streams and air-induced spray patterns nozzles or combinations thereof. These nozzles may be used to discharge chemicals like liquid/granular fertilizers, pesticides, insecticides, herbicides, fungicides, desiccants and any such variants thereof. Also, these nozzles may be capable of discharging extremely fine chemicals to extremely coarse chemicals. The nozzles may be made up of engineered plastic (e.g., polyacetal), polypropylene, ceramic, stainless steel, soft metals like aluminum or brass, or of any other known types materials or combinations thereof. Moreover, each nozzle is configured to be placed into an active position by rotation of the nozzle turret. There may be one or more than one nozzle that is configured to be placeable into the active position. The nozzles in the active position may be in arranged in a consecutive, alternate, opposed and/or diagonal manner. The rotation of the nozzle turret, to place the nozzles into active position, may be achieved automatically with the help of a motor operable from an operator station or remotely and/or manually by an operator.

Further, a transponder tag is placed on each nozzle of the nozzle body. The transponder tag may be a passive radio frequency identification (RFID) tag. Alternatively, the transponder tag may include semi-passive RFID, active RFID, low frequency, high frequency, or ultra-high frequency tags. Moreover, the tag comprises specific information including characteristics of the respective nozzle, wherein, the specific information of the nozzle includes type of the nozzle, size of the nozzle and spray angle.

Further, a reader assembly includes an antenna and a controller. The reader assembly is configured to emit electromagnetic waves through the antenna to receive information from a particular transponder tag. Furthermore, the transponder tag is configured to receive the electromagnetic waves and generate a signal back to the reader assembly with the specific information for the respective nozzle. The reader assembly is placed at a location on the spray boom assembly so as to be in range of communication with the respective transponder tag of the respective nozzle when the nozzle is placed into the active position. In various implementations, the reader assembly is placed on a stationary portion of the nozzle body such that the tag enters a range of communication with the respective transponder tag of the respective nozzle when the respective nozzle is placed in the active position. Alternatively, the reader assembly may be placed on the boom or on components attached to the boom, which may be a predetermined distance from the tag.

Further, the controller is configured to receive the specific information from the respective transponder tag to identify characteristics of the respective nozzle being placed by rotation into the active position. The controller may be configured to vary sprayer settings based on the identified nozzle in the active position, the nozzle's characteristics and the specific spraying requirements. The sprayer settings may include one or more of boom height, spray pressure, sprayer speed, spray drift and combinations thereof.

Moreover, the controller may store and retrieve data related to the specific spraying requirements. The agricultural machine may comprise a global positioning system (GPS) which may store positioning data of the agricultural machine at a field location. The controller may store and retrieve the positioning data and utilization of the appropriate nozzle as per crop requirement at a particular position. This data may be used as historic data in future agricultural machine operations.

A method of identifying a nozzle mounted on a spray boom assembly of an agricultural machine is in an active position and the characteristics of the nozzle is disclosed. The method includes placing the nozzle into an active position by rotation, thereby placing a respective transponder tag in communication range with a reader assembly; emitting primary electromagnetic waves through an antenna of the reader assembly; and receiving the primary electromagnetic waves by the respective transponder tag. The respective transponder tag is energized upon receiving the primary electromagnetic waves in order to generate secondary electromagnetic waves based on specific information for the respective nozzle. Secondary electromagnetic waves are emitted by the respective transponder tag and the secondary electromagnetic waves are received by the reader assembly. Identifying, by the controller, the nozzle in the active position and its characteristics based on the secondary electromagnetic waves. The method may further include storing and retrieving, by the controller, data related to specific spraying requirements. Further, the method may also include varying sprayer settings by the controller based on the identified nozzle in the active position and its characteristics and the specific spraying requirements.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a rear side perspective view of an agricultural sprayer with laterally extended spray booms.

FIG. 2 is a schematic view of a nozzle body with a plurality of mounted nozzles according to the principles of the present disclosure.

FIG. 3 is a detailed view of a nozzle in an active position, a reader assembly and a transponder tag.

In the drawings, reference numbers may be reused to identify similar and/or identical elements.

### DETAILED DESCRIPTION

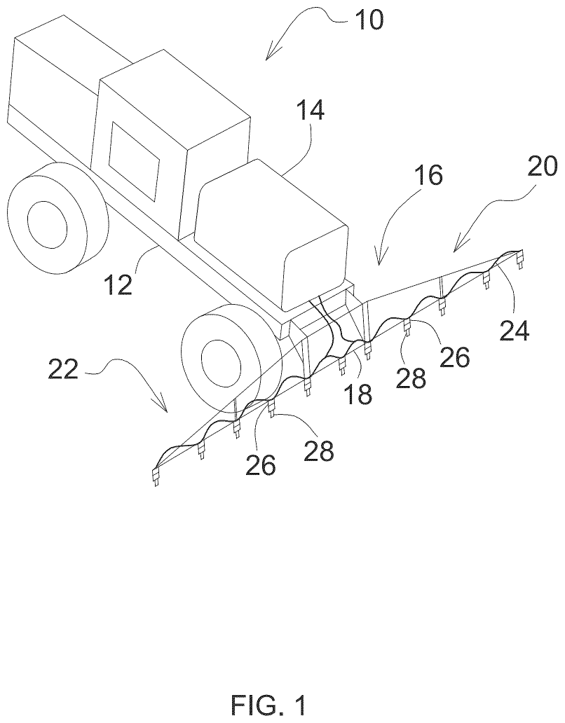

Referring now to FIG. 1, there is shown an agricultural machine such as a self-propelled agricultural sprayer 10. In some implementations, the agricultural machine may be a trailed or a mounted sprayer. The agricultural sprayer 10 includes a chassis 12 that provides a structure for mounting numerous components associated with the agricultural sprayer 10 thereon. For example, the agricultural sprayer 10 includes a liquid tank 14 which stores a spray liquid comprising chemicals such as liquid/granular fertilizers, pesticides, insecticides, herbicides, fungicides, desiccants and any such chemicals thereof to be sprayed on a field. The liquid tank 14 is mounted on the chassis 12. The agricultural sprayer 10 also includes a spray boom assembly 16 located at a rear position of the agricultural sprayer 10. In alternative implementations, the spray boom assembly 16 may be located at different locations on the agricultural sprayer—for example, at a front end or in a mid-portion of the agricultural sprayer 10. The spray boom assembly 16 comprises a center frame 18 and laterally extendable right and left booms 20, 22. Further, the spray boom assembly 16 is operable to distribute the chemicals in the liquid tank 14 over a wide area in the field through a conduit 24, associated with the spray boom assembly 16. The spray boom assembly 14 comprises at least one nozzle body 26, which is placed at a bottom side of the spray boom assembly 16. The nozzle body 26 includes stationary and/or respectively non-rotating portions and a rotatable nozzle turret 42 on which a plurality of nozzles 28 are mounted. The plurality of nozzles 28 mounted to the nozzle turret 42 may include two or more nozzles. For example, six nozzles may be mounted in a circular fashion on the nozzle turret 42. Each nozzle 28 is configured to be placed into an active position 44 by rotation of the nozzle turret 42 to discharge liquid chemicals as the agricultural sprayer 10 is moves through a field of crop or plants.

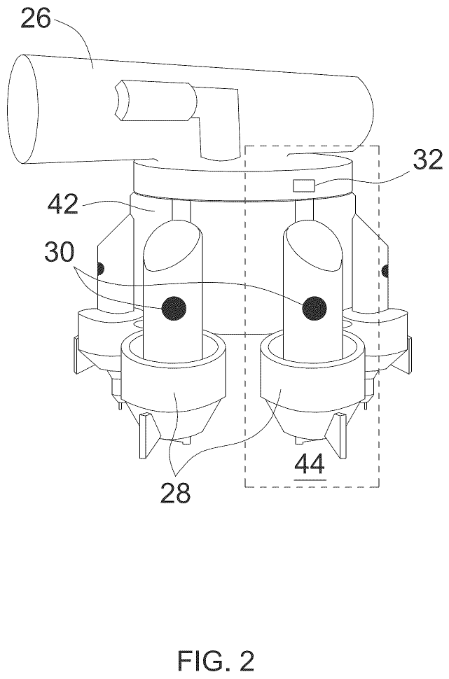

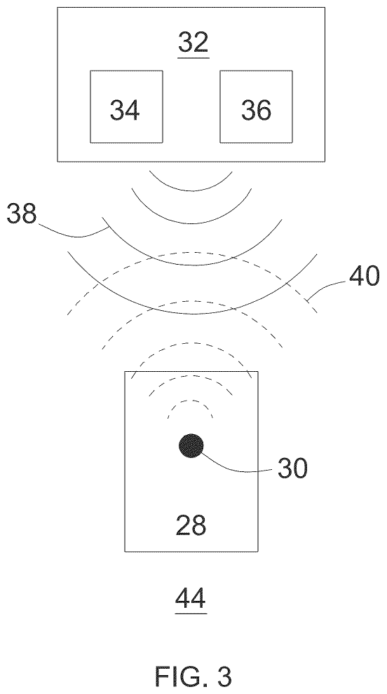

As shown in FIGS. 2 and 3, a transponder tag 30 is placed on each nozzle 28 of the nozzle body 26. In various implementations, the transponder tag 30 is a passive radio frequency identification (RFID) tag. Further, the tag 30 includes specific information regarding characteristics of each respective nozzle 28. The specific information of the nozzle 28 may include the type of the nozzle, size of the nozzle and spray angle. Further, a reader assembly 32 is placed on a location of the spray boom assembly 16 such that the a reader assembly 32 is in communication range with the respective transponder tag 30 of the respective nozzle 28 when the nozzle 28 is rotated into the active position 44. In various implementations, the reader assembly 32, in particular the antenna 34, is placed on the stationary portion of the nozzle body 26 in such way that it enters communication range with the respective transponder tag 30 of the respective nozzle 28 when the respective nozzle 28 is placed in the active position 44 by rotation. The reader assembly 32 includes an antenna 34 and a controller 36. The reader assembly 32 is configured to emit electromagnetic waves 38 through the antenna 34 to receive information from the particular transponder tag 30 of the respective each nozzle 28. Furthermore, the transponder tag 30 is configured to receive the electromagnetic waves 38 and generate a signal 40 back to the reader assembly 32 with the specific information for the respective nozzle 28. The controller 36 is configured to receive the specific information from the respective transponder tag 30 to identify characteristics of the respective nozzle 28 being placed, by rotation, into the active position 44.

A method includes placing a nozzle 28 into an active position 44 via rotation of the nozzle turret 42. The rotation of the nozzle turret 42 may be achieved automatically with the help of a motor operable from an operator station or remotely. For example, six nozzles may be mounted in a circular fashion on the nozzle turret 42, out of which two opposed or consecutive or alternate nozzles 28 may be placed in the active position 44 by the rotation of the nozzle turret 42. The placement of the nozzle 28 in the active position 44 brings the transponder tag 30 of the nozzles 28 in the active position 44 into range of communication with the reader assembly 34. The reader assembly 32 emits primary electromagnetic waves 38 through the antenna 34. These primary electromagnetic waves 38 are received by the respective transponder tag 30 of the nozzle 28 in the active position 44. Upon receiving the primary electromagnetic waves 38, the respective transponder tag 30 gets energized and in turn generates secondary electromagnetic waves 40 based on specific information for the respective nozzle 28. Further, the respective transponder tag 30 emits the secondary electromagnetic waves 40 which contain specific information for the respective nozzle 28. Then, the reader assembly 32 receives the secondary electromagnetic waves 40 that are based on specific information for the respective nozzle 28. Based on the secondary electromagnetic waves 40 along with the specific information for the respective nozzle 28, the controller 36 identifies the nozzle 28 in the active position 44 and its characteristics. The controller 36 and the antenna 34 together may form the reader assembly 32 as a single or integral device. Alternatively, a separate controller 36 and a separate antenna 34 may form the reader assembly 32. Further, the controller 36 may adjust settings of the sprayer based on the identified nozzle 28 in the active position 44, its characteristics and the specific spraying requirements. The sprayer settings may include one or more of boom height, spray pressure, sprayer speed, spray drift and combination thereof.

The controller 36 may store and retrieve data related to specific spraying requirements. The agricultural machine 10 may include a global positioning system (GPS) which may store positioning data of the agricultural machine at a field location. The controller 36 may store and retrieve the positioning data and utilization of the appropriate nozzle 28 as a per crop requirement at particular positions. This data may be used as historic data in future operations of agricultural machines.

What is claimed is:

1. An agricultural machine comprising:
a chassis;
a liquid tank;
a spray boom assembly with a center frame and laterally extendable right and left booms;
a conduit located on the spray boom assembly and defining a liquid flow;
a nozzle body located at a bottom side of the boom, in fluid communication with the liquid tank via the conduit, and including a plurality of nozzles, a stationary portion, and a nozzle turret, wherein the nozzle turret is rotatable, the plurality of nozzles are mounted to the nozzle turret, and each nozzle of the plurality of nozzles is configured to be placed into an active position by rotation of the nozzle turret,
a transponder tag for each nozzle of the plurality of nozzles, wherein each transponder tag includes specific information corresponding to characteristics of each respective nozzle of the plurality of nozzles; and
a reader assembly including an antenna and a controller, wherein the reader assembly is configured to emit electromagnetic waves through the antenna to receive information from a particular transponder tag,
wherein, each transponder tag is configured to receive the electromagnetic waves and generate a signal back to the reader assembly with the specific information for the respective nozzle of the plurality of nozzles,
wherein the reader assembly is located on the agricultural machine in a location such that each transponder tag is in communication range with the reader assembly when the respective nozzle of the plurality of nozzles is placed into the active position, and
wherein the controller is configured to receive the specific information from the particular transponder tag and identify characteristics of the respective nozzle of the plurality of nozzles.

2. The agricultural machine of claim 1, wherein the transponder tag is a passive radio frequency identification tag.

3. The agricultural machine of claim 1, wherein the controller is configured to store and retrieve data related to specific spraying requirements.

4. The agricultural machine of claim 1, wherein the controller is configured to vary spray settings of the agricultural machine based on the identified nozzle in the active position and the characteristics of identified nozzle, and the specific spraying requirements.

5. The agricultural machine of claim 4, wherein the spray settings include one or more of boom height, spray pressure, sprayer speed, and spray drift.

6. The agricultural machine of claim 1, wherein the specific information includes a nozzle type, a nozzle size, or a spray angle.

7. The agricultural machine of claim 1, wherein the reader assembly is located on the stationary portion of the nozzle body and the transponder tag is located on the rotatable nozzle turret.

8. The agricultural machine of claim 1, wherein the chassis is configured to be towed.

9. A nozzle identification method comprising:
placing a nozzle into an active position by rotating a nozzle turret;
placing a transponder tag associated with the nozzle in communication range with a reader assembly;
emitting primary electromagnetic waves through an antenna of the reader assembly;
receiving the primary electromagnetic waves by the transponder tag;
energizing the transponder tag upon receiving the primary electromagnetic waves;
generating and emitting, by the transponder tag, secondary electromagnetic waves based on specific information associated with nozzle;
receiving the secondary electromagnetic waves by the reader assembly;
determining, by a controller, that the nozzle is in an active position; and
identifying, by the controller, characteristics of the nozzle based on the secondary electromagnetic waves.

10. The method of claim 9, further comprising storing, by the controller, data related to specific spraying requirements.

11. The method of claim 10, further comprising varying, by the controller, sprayer settings based on the determined nozzle in the active position, the identified characteristics of the nozzle, and the specific spraying requirements.
